(19) United States
(12) Patent Application Publication
(10) Pub. No.: US 2006/0165521 A1
(43) Pub. Date: Jul. 27, 2006

(54) Scroll casing for centrifugal blowers

(76) Inventor: Jae-Won Kim, Seoul (KR)

Correspondence Address: DICKSTEIN SHAPIRO MORIN & OSHINSKY LLP, 2101 L Street, NW, Washington, DC, 20037, US

(21) Appl. No.: 11/170,113

(22) Filed: Jun. 30, 2005

(30) Foreign Application Priority Data
Jan. 25, 2005 (KR) 10-2005-0006754

(51) Int. Cl. F03B 3/16

(52) U.S. Cl. 415/204

(57) ABSTRACT

Disclosed herein is a scroll casing for centrifugal blowers provided outside of an impeller for forming a spiral air flow path, comprising: an outlet for discharging air; and a cut-off formed between the impeller and the outlet for serving as a boundary between an outlet air flow field and an internal air flow field wherein when a difference in pressure between an inlet and outlet of the centrifugal blower, indicated by a height of a water column, is designated by Δp (expressed in mm Aq), a water density is designated by ρ, a gravitational acceleration is designated by g, an outer diameter of the impeller is designated by D, and an angle of a circular arc defined from a position of the cut-off to a position where an expansion of the scroll casing ends is designated by θ (expressed in radians), an equation θ=(7π/4)−{(Δp)/(ρ g D)}×(π/180) is satisfied, thereby balancing the internal air flow and the outlet air flow even when a centrifugal blower is operated under high suction pressure condition, and thus, enhancing the performance of the centrifugal blower.

### BACKGROUND OF THE INVENTION

1. Field of the Invention

The present invention relates generally to scroll casings for centrifugal blowers and, more particularly, to a scroll casing for centrifugal blowers which is used under a high suction pressure greater than atmospheric pressure.

2. Description of the Related Art

Recently, according to industrial development, the public's interest in the environment has increased. As a result, new products, such as an air cleaner having an air blowing system, have been developed, and the application area of blowers has been expanded. Therefore, the development of a blower adapted for high suction pressure operation condition as well as atmospheric suction pressure operation condition (no load operation) is required. However, when the conventional centrifugal blowers is operated under high suction pressure condition, the efficiency thereof is reduced by 50% or more in comparison with when it is operated under atmospheric suction pressure condition.

Generally, as shown in FIG. 1, a conventional centrifugal blower includes an impeller 2 having a plurality of blades arranged in a circular shape, and a scroll casing 4 formed outside of the impeller 2 for forming a spiral flow path in the scroll casing 4. An inlet (not shown) is formed at a predetermined position in the scroll casing 4 in the same direction as the axis of the impeller 2, so as to draw air into the scroll casing 4. An outlet 6 is formed at a predetermined position in the scroll casing 4 in a direction perpendicular to the inlet.

In the conventional centrifugal blower having the above-mentioned construction, air is drawn into the impeller 2 by rotation of the impeller 2 and comes out of the impeller 2 in a radial direction of the impeller 2. Thereafter, the air changes in pressure due to the shape of the scroll casing 4 while flowing to the outlet 6, and then, the air having the predetermined pressure is discharged through the outlet 6 to the atmosphere. In view of the aerodynamics, the scroll casing 4 governs the process of energy transformation, starting from the cut off 8 for serving as a boundary between an outlet air flow field and an internal air flow field, for transforming the dynamic pressure of the air into static pressure along the wall surface of the scroll casing 4. Therefore, the scroll casing 4 has a big influence on the performance of the centrifugal blower.

The conventional centrifugal blower was manufactured in consideration of the outflow amount and pressure of air, and an operation environment under atmospheric suction pressure conditions (no load).

Since the conventional centrifugal blower was manufactured according to the operation condition of the atmospheric suction pressure, as shown in FIG. 2, when it is operated under atmospheric pressure, both the internal air flow field (air flow state from the impeller 2 to the cut-off 8) and the outflow field (air flow state from the cut-off 8 to the outlet 6) are stable and even. However, when the conventional centrifugal blower is operated under high suction pressure condition, abnormal flow such as divergence occurs around the cut-off in the internal air flow field, as shown in a circled portion A of FIG. 3. Also, the air outflow gravitates toward the cut-off 8, and turbulent flow occurs around the wall of the scroll casing 4 adjacent to the outlet 6. As such, the conventional centrifugal blower is problematic in that its performance is greatly deteriorated under high suction pressure.

### SUMMARY OF THE INVENTION

Accordingly, the present invention has been provided to solve the above problems occurring in the prior art, and an object of the present invention is to provide a scroll casing for centrifugal blower in which an impeller is provided such that a scroll casing for centrifugal blower provided outside of an impeller for forming a spiral air flow path, comprising: an outlet for discharging air; and a cut-off formed between the impeller and the outlet for serving as a boundary between an outlet air flow field and an internal air flow field wherein when a difference in pressure between an inlet and outlet of the centrifugal blower, indicated by a height of a water column, is designated by Δp (expressed in mm Aq), a water density is designated by ρ, a gravitational acceleration is designated by g, an outer diameter of the impeller is designated by D, and an angle of a circular arc defined from a position of the cut-off to a position where an expansion of the scroll casing ends is designated by θ (expressed in radians), an equation θ=(7π/4)−{(Δp)/(ρ g D)}×(π/180) is satisfied.

The cut-off may have a curvature radius (R) ranging from 0.03 D to 0.055 D.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a view showing a conventional centrifugal blower;

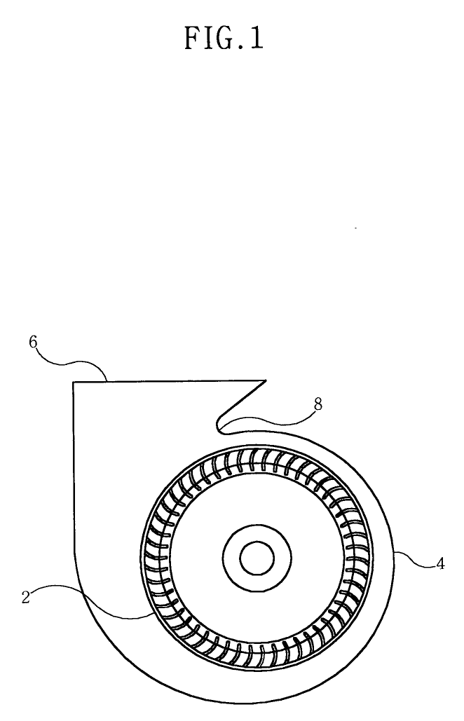

FIG. 2 is a view showing air flow state in the centrifugal blower of FIG. 1 under no load operation (atmospheric pressure suction);

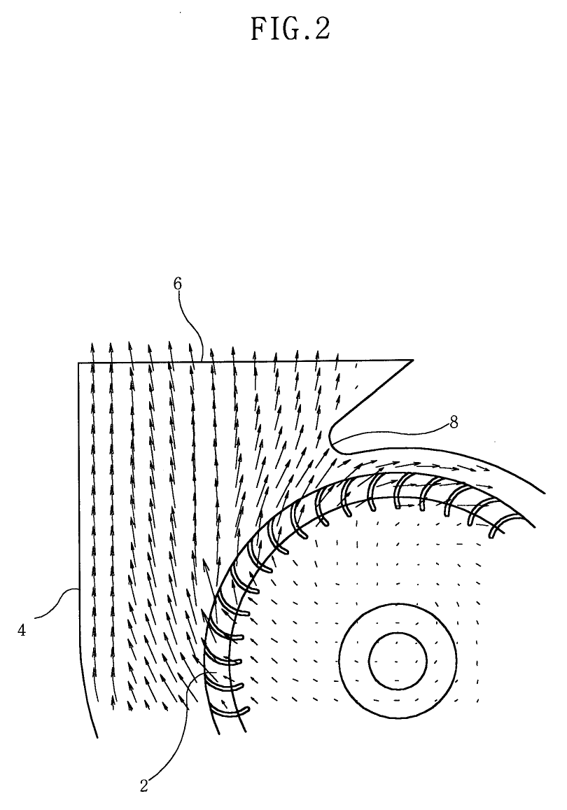

FIG. 3 is a view showing air flow state in the centrifugal blower of FIG. 1 under high pressure operation (high pressure suction); and

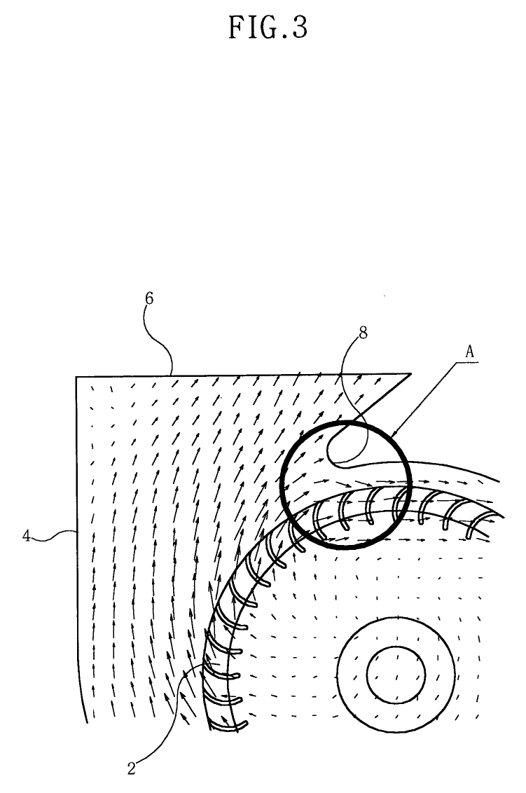

FIG. 4 is a schematic view of a centrifugal blower having a scroll casing according to the present invention, on which factors determining the shape of the scroll casing are represented.

### DESCRIPTION OF THE PREFERRED EMBODIMENTS

A preferred embodiment of the present invention will now be described in detail with reference to the attached drawings.

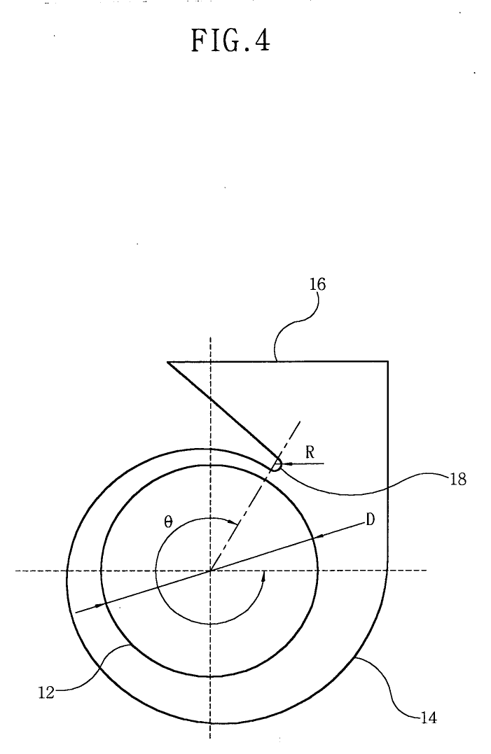

As shown in FIG. 4, a centrifugal blower, to which the present invention is applied, includes an impeller 12 which has a plurality of blades arranged in a circular shape, and a scroll casing 14 formed outside of the impeller 12 for forming a spiral flow path. The scroll casing 14 includes an inlet (not shown) which is formed at a predetermined position in the scroll casing 14 in the same direction as the axis of the impeller 12. Air is drawn into the scroll casing 14 through the inlet. The scroll casing 14 further includes an outlet 16 which is formed at a predetermined position in the scroll casing 14 in a direction perpendicular to the inlet, and a cut-off 18 for being provided between the impeller 12 and the outlet 16 for serving as a boundary between an outlet air flow field and an internal air flow field.

When the difference in pressure between an inlet side and an outlet side of the centrifugal blower, indicated by the height of a water column, is designated by Δp (expressed in mm Aq), the density of water is designated by ρ, gravitational acceleration is designated by g, the outer diameter of the impeller 12 is designated by D, and the angle of a circular arc defined from a position of the cut-off 18 to a position where an expansion of the scroll casing ends is designated by θ (expressed in radians), the scroll casing 14 has a shape satisfying the equation θ=(7π/4)−{(Δp)/(ρ g D)}×(π/180). The angle θ corresponds to the size of an air suction area. The cut-off 18 has a curvature radius (R) ranging from 0.03 D to 0.055 D.

The following Table shows a test result of the centrifugal blower manufactured according to the present invention where a performance of the blower according to according to the changes of the air suction area (represented by angle θ) and the curvature radius (R) of the cut-off 18 while maintaining the geometrical and operational conditions of the impeller 12 is represented by a flow coefficient and a pressure coefficient.

The test was conducted under conditions such that the pressure difference Δp between the inlet side and the outlet side of the centrifugal blower, indicated by the height of the water column, was within a range from 23 mm Aq. to 50mm Aq. Other conditions of the test were as follows.

Equipment for the test: a wind tunnel which has a flux range from 1.5 to 50 m³/min and is designed and manufactured in accordance with the standards of the American Society of Heating, Refrigerating and Air-conditioning Engineers (ASHRAE).

Test method: based on KS (Korean Standard) 6311.

TABLE

| θ \ R | 0.02D | 0.03D | 0.04D | 0.05D | 0.06D | 0.10D | 0.12D |
|---|---|---|---|---|---|---|---|
| 0.85θ | 3.32 | 4.11 | 4.15 | 4.17 | 3.92 | 3.56 | 3.19 |
| 0.90θ | 3.92 | 4.22 | 4.23 | 4.22 | 4.01 | 3.85 | 3.32 |
| 1.00θ | 3.90 | 4.05 | 4.17 | 4.21 | 4.05 | 3.91 | 3.01 |
| 1.05θ | 3.98 | 4.02 | 4.05 | 4.20 | 3.82 | 3.89 | 2.99 |
| 1.10θ | 3.91 | 4.00 | 4.01 | 4.08 | 3.68 | 3.73 | 2.86 |
| 1.15θ | 3.82 | 3.85 | 3.87 | 3.92 | 3.52 | 3.66 | 2.76 |
| 1.20θ | 3.78 | 3.78 | 3.63 | 3.65 | 3.52 | 3.59 | 2.69 |
| 1.30θ | 3.52 | 3.55 | 3.43 | 3.31 | 3.34 | 3.37 | 2.53 |

From the Table, it is understood that the performance of the centrifugal blower according to the present invention is greatly superior when inflow-side pressure is greater than atmospheric pressure (but 50 mm Aq or less). Furthermore, in the case that the curvature radius (R) of the cut-off 18 ranges from 0.03 D to 0.06 D, the performance of the centrifugal blower is further enhanced. The optimal performance of the centrifugal blower is attained when the curvature radius (R) of the cut-off 18 is within a range from 0.04 D to 0.06 D. Therefore, in this regard, the curvature radius (R) of the cut-off 18 preferably ranges from 0.035 D to 0.055 D.

As such, the scroll casing of the present invention can optimize the characteristics of internal air flow of the centrifugal blower even under high suction pressure environment. Furthermore, the internal air flow field and the outlet air flow field are balanced based on the cut-off. As a result, the performance of the centrifugal blower is markedly enhanced.

As described above, the present invention provides a scroll casing for centrifugal blowers by which both internal air flow and outflow are balanced even when a centrifugal blower is operated under high suction pressure condition, thus enhancing the performance of the centrifugal blower.

Although the preferred embodiment of the present invention has been disclosed for illustrative purposes, those skilled in the art will appreciate that various modifications, additions and substitutions are possible, without departing from the scope and spirit of the invention as disclosed in the accompanying claims.

What is claimed is:

1. A scroll casing for centrifugal blower provided outside of an impeller for forming a spiral air flow path, comprising:
an outlet for discharging air; and
a cut-off formed between the impeller and the outlet for serving as a boundary between an outlet air flow field and an internal air flow field wherein
when a difference in pressure between an inlet and outlet of the centrifugal blower, indicated by a height of a water column, is designated by Δp (expressed in mm Aq), a water density is designated by ρ, a gravitational acceleration is designated by g, an outer diameter of the impeller is designated by D, and an angle of a circular arc defined from a position of the cut-off to a position where an expansion of the scroll casing ends is designated by θ (expressed in radians), an equation θ=(7π/4)−{(Δp)/(ρ g D)}×(π/180) is satisfied.

2. The scroll casing as set forth in claim 1, wherein the cut-off has a curvature radius (R) ranging from 0.03 D to 0.055 D.
